(19) United States
(12) Patent Application Publication
(10) Pub. No.: US 2013/0293493 A1
(43) Pub. Date: Nov. 7, 2013

(54) SIGNAL TRANSMITTING METHOD OF TOUCH INPUT DEVICES

(71) Applicant: KYE SYSTEMS CORP., New Taipei (TW)

(72) Inventors: Tsung-Hsien SHEN, New Taipei (TW); Jui-Tse CHEN, New Taipei (TW)

(73) Assignee: KYE SYSTEMS CORP., New Taipei (TW)

(21) Appl. No.: 13/868,315

(22) Filed: Apr. 23, 2013

(30) Foreign Application Priority Data
May 2, 2012 (TW) 101115667

(51) Int. Cl. G06F 3/0488

(52) U.S. Cl. CPC G06F 3/0488
USPC 345/173

(57) ABSTRACT

A signal transmitting method of a touch input device is adapted to the touch input device and a computer device connected with each other. According to an embodiment, the signal transmitting method includes the following steps. A touch signal is obtained by using a touch input device. When the touch signal corresponds to a mouse mode, the touch signal is transmitted to an inbuilt mouse driver of the computer device through a first channel. When the touch signal corresponds to a touchpad mode, the touch signal is transmitted to an inbuilt touchpad driver of the computer device through a second channel different from the first channel. Thus, a single touch input device can be used as a mouse and a touch pad, and provide different input signals to the computer device.

### CROSS-REFERENCE TO RELATED APPLICATIONS

This non-provisional application claims priority under 35 U.S.C. §119(a) on Patent Application No(s). 101115667 filed in Taiwan, R.O.C. on May 2, 2012, the entire contents of which are hereby incorporated by reference.

### BACKGROUND

1. Technical Field

The disclosure relates to a signal transmitting method of a touch input device, and more particularly to a signal transmitting method of a touch input device transmitting signals using different channels.

2. Related Art

With the development and popularization of computer technologies, various computers including tablet computers, notebook computers and desktop computers, have become working and entertainment tools for most users. People may use a mouse, a trackball, a keyboard or a touchpad as a peripheral input device of a multimedia computer. Now, it becomes a popular way to input texts or images to the computer through a touchpad.

However, in order to meet different input requirements or to meet different settings of application programs, sometimes a plurality of input devices, e.g. a mouse, a keyboard and a touchpad, need to be connected to the computer simultaneously. This causes usage inconvenience and clutter. Moreover, the functions of these input devices may partially cover each other, causing a waste of resources.

In order to combine input devices, the US Patent Application No. 2012/0026077 field on Jul. 28, 2010 provides a track pad and a method for mapping a track pad operation to a touch screen event, which has disclosed that a user's gestures on a specific single track pad are mapped to various touch screen events. However, the track pad additionally requires a specific driver installed in a computer connected to the track pad, to work. In other words, the track pad provided in the US Patent Application No. 2012/0026077 cannot be applied to present computers. Therefore, the track pad and the mapping method have rather poor universality.

### SUMMARY

In view of the above problem, a signal transmitting method of a touch input device provided by the disclosure according to an embodiment is adapted to the touch input device and a computer device connected with each other, and includes the following steps. A touch signal is obtained by using the touch input device. When the touch signal corresponds to a mouse mode, the touch signal is transmitted to an inbuilt mouse driver of the computer device through a first channel. When the touch signal corresponds to a touchpad mode, the touch signal is transmitted to an inbuilt touchpad driver of the computer device through a second channel different from the first channel.

The touch input device includes, for example, a track sensing zone and one of a left button zone and a right button zone, and determines a mode corresponding to the touch signal, according to at least touched one of the track sensing zone and the left or right button zone and an operation on the at least touched one of the track sensing zone and the left or right button zone.

In an embodiment, when the touch signal is generated by directly touching the track sensing zone at a single touch point and then sliding on the track sensing zone, the touch signal corresponds to the mouse mode.

In an embodiment, when the touch signal is generated by a single click at a single touch point on the left button zone or the right button zone, the touch signal corresponds to the mouse mode.

In an embodiment, when the touch signal is generated by a single click or a double click on the track sensing zone, the touch signal corresponds to the touchpad mode.

In an embodiment, when the touch signal is generated by touching the track sensing zone at a single touch point and then sliding on the track sensing zone, the touch signal corresponds to the touchpad mode.

In an embodiment, when the touch signal is generated by continuously pressing the track sensing zone at a single touch point, the touch signal corresponds to the touchpad mode.

In an embodiment, when the touch signal is generated by continuously pressing the left button zone or the right button zone at a single touch point and by a single click on the track sensing zone simultaneously, the touch signal corresponds to the touchpad mode.

In an embodiment, when the touch signal is continuously pressing the left button zone or the right button zone at a single touch point and sliding on the track sensing zone simultaneously, the touch signal corresponds to the touchpad mode.

In an embodiment, the step of transmitting the touch signal to the inbuilt mouse driver of the computer device through the first channel includes the following steps. The touch signal is packaged into a mouse input packet, and a header identification (HID) of the mouse input packet corresponds to the mouse mode. The mouse input packet is transmitted to the inbuilt mouse driver of the computer device.

Moreover, the step of transmitting the touch signal to the inbuilt touchpad driver of the computer device through the second channel includes the following steps. The touch signal is packaged into a touchpad input packet, and an HID of the touchpad input packet corresponds to the touchpad mode. The touchpad input packet is transmitted to the inbuilt touchpad driver of the computer device.

In an embodiment, the touch input device transmits the mouse input packet or the touchpad input packet to the computer device wiredly or wirelessly.

A signal transmitting method of a touch input device provided by the disclosure according to an embodiment includes the following steps. A touch signal is obtained by using the touch input device. When the touch signal corresponds to a mouse mode, a mouse input packet carrying the touch signal is transmitted to a computer device through a first channel. When the touch signal corresponds to a touchpad mode, a touchpad input packet carrying the touch signal is transmitted to the computer device through a second channel different from the first channel.

As set forth above, the touch input device can provide the mouse function and the touchpad function at the same time, so the command input is more efficient. Moreover, the touch input device can send the touch signal to the original driver in the computer device according to the mode corresponding to the touch signal, thereby having excellent universality.

### BRIEF DESCRIPTION OF THE DRAWINGS

The disclosure will become more fully understood from the detailed description given herein below for illustration only, and thus is not limitative of the disclosure, and wherein:

FIG. 1 is a schematic block diagram of a touch input device and a computer device according to an embodiment;

FIG. 2 is a flow chart of a signal transmitting method of a touch input device according to an embodiment;

FIG. 3A is a schematic diagram of an operation causing a touch signal corresponding to a mouse mode according to an embodiment;

FIG. 3B is a schematic diagram of an operation causing a touch signal corresponding to a mouse mode according to an embodiment;

FIG. 4A is a schematic diagram of an operation causing a touch signal corresponding to a touchpad mode according to an embodiment;

FIG. 4B is a schematic diagram of an operation causing a touch signal corresponding to a touchpad mode according to an embodiment;

FIG. 4C is a schematic diagram of an operation causing a touch signal corresponding to a touchpad mode according to an embodiment;

FIG. 4D is a schematic diagram of an operation causing a touch signal corresponding to a touchpad mode according to an embodiment;

FIG. 4E is a schematic diagram of an operation causing a touch signal corresponding to a touchpad mode according to an embodiment;

FIG. 4F is a schematic diagram of an operation causing a touch signal corresponding to a touchpad mode according to an embodiment;

FIG. 5A is a flow chart of Step S130 according to an embodiment;

FIG. 5B is a flow chart of Step S140 according to an embodiment; and

FIG. 6 is a flow chart of a signal transmitting method of a touch input device according to an embodiment.

### DETAILED DESCRIPTION

Detailed features and advantages of the disclosure are described in the embodiments below, and their content is adequate for those skilled in the art to understand the technical content of the disclosure and to implement the disclosure. According to the content disclosed in the specification, the claims, and the drawings, those skilled in the art can easily understand the objects and advantages of the disclosure.

The disclosure provides a signal transmitting method of a touch input device, which is adapted to the touch input device and a computer device connected with each other.

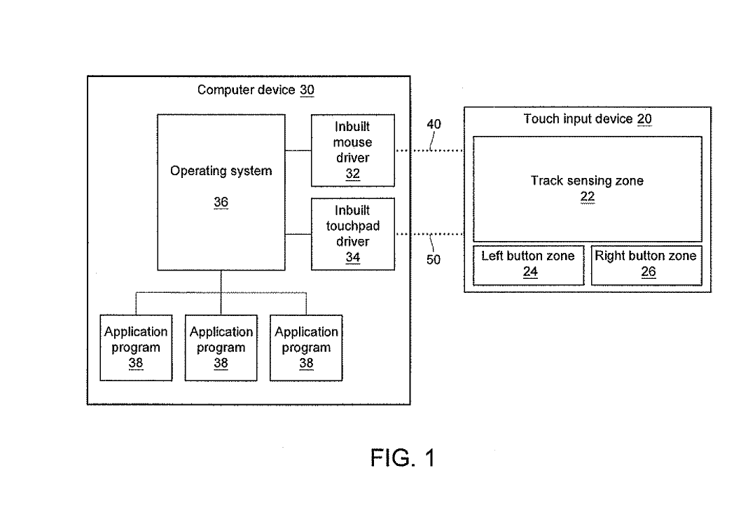

FIG. 1 is a schematic block diagram of a touch input device and a computer device according to an embodiment. A touch input device 20 includes a touch panel, and the touch panel supports at least one of a multi-touch function and a single touch function. According to an embodiment, the touch panel is divided into a track sensing zone 22, a left button zone 24 and a right button zone 26. When the touch panel is touched with an object such as a finger or a touch pen, the touch input device 20 generates at least one touch signal in response to a touched zone and an operation on the touched zone, and sends the touch signal to the computer device 30.

The computer device 30 is, for example, a Personal Digital Assistant (PDA), a notebook computer, a desktop computer, a tablet computer or a mobile phone. The touch input device 20 is, for example, used as a peripheral device of the computer device 30. The user can use the touch input device 20 to control a cursor displayed on a display device connected to the computer device 30, thereby operating the computer device 30.

In this embodiment and some embodiments, the computer device 30 includes an inbuilt mouse driver 32, an inbuilt touchpad driver 34, an operating system 36 and at least one application program 38. The inbuilt mouse driver 32 and the inbuilt touchpad driver 34 are, for example, default inbuilt drivers of the computer device 30. For example, the inbuilt mouse driver 32 and the inbuilt touchpad driver 34 are provided by a third-party mouse and touchpad manufacturer to a manufacturer of the computer device 30, so that the computer device 30 is capable of corresponding to various existing mice and touchpads.

In this embodiment and some embodiments, the operating system 36 is connected to the inbuilt mouse driver 32 and the inbuilt touchpad driver 34, so as to calculate a displayed location of the cursor on screen, or to process various touch signals according to the application program 38 that is being executed. For example, according to the touch signal, the computer device 30 zooms in or out an object displayed on screen. The object is, for example, a webpage, a window page, an image, or a selected object in the application program 38 such as MS paint.

According to an embodiment, a single touch input device 20 has a mouse mode and a touchpad mode. Thus, the touch input device 20 can be used as a regular mouse and a regular touchpad, and can provide the computer device 30 with different touch signals corresponding to the mouse mode and the touchpad mode. When the touch input device 20 is connected to the computer device 30, the computer device 30 does not need to install a new driver for the touch input device 20. In contrast, the original inbuilt mouse driver 32 and the original inbuilt touchpad driver 34 are used to process the touch signal received from the touch input device 20. The signal transmitting method of the touch input device 20 is described as follows.

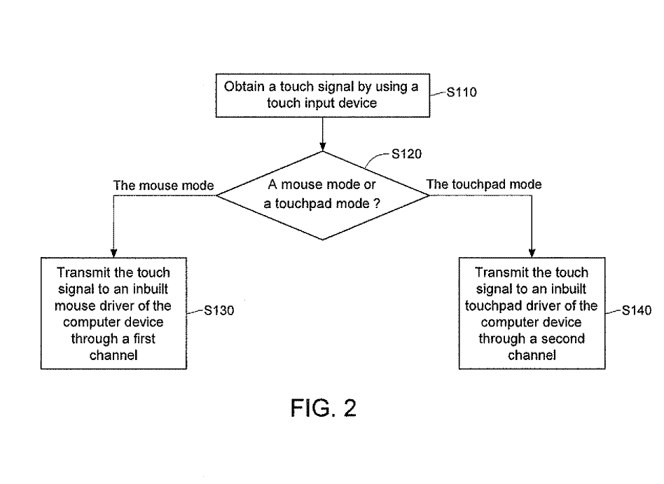

FIG. 2 is a flow chart of a signal transmitting method of a touch input device according to an embodiment. First, a touch signal is obtained by using a touch input device 20 (Step S110), and whether the obtained touch signal corresponds to a mouse mode or a touchpad mode is determined (Step S120). When the touch signal corresponds to the mouse mode, the touch input device 20 transmits the touch signal to an inbuilt mouse driver 32 of a computer device 30 through a first channel 40 (Step S130). When the touch signal corresponds to the touchpad mode, the touch input device 20 transmits the touch signal to an inbuilt touchpad driver 34 of the computer device 30 through a second channel 50 (Step S140).

Definitions of touch signals corresponding to the mouse mode or the touchpad mode can be set by gestures that can form these touch signals hereinafter. Through these definitions, the mode corresponding to the obtained touch signal can be determined in step S120. Various embodiments of operations of human fingers touching a surface of a touch panel of the touch input device 20 are described as follows.

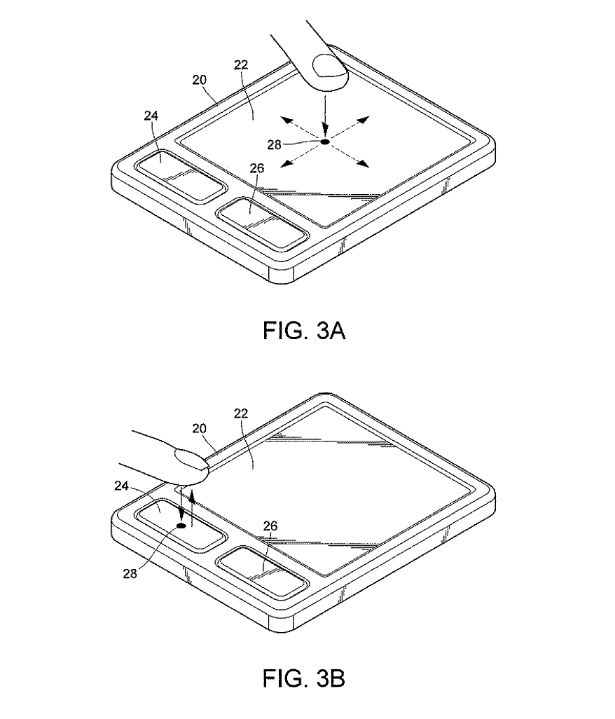

FIG. 3A and FIG. 3B are respectively schematic diagrams of operations causing the touch signal corresponding to a mouse mode according to different embodiments. When a track sensing zone 22, a left button zone 24 or a right button zone 26 is being touched, a touch point 28 is formed at a touched location. According to user's operations, one or more touch points 28 can be formed. When the finger directly touches the track sensing zone 22 at the touch point 28 and then slides on the track sensing zone 22 (as shown in FIG. 3A), the touch signal corresponds to the mouse mode. Herein, the touch signal caused by the operation shown in FIG. 3A represents an instruction that a user operates the mouse to control the cursor.

When the finger does a single clicking at the touch point 28 on the left button zone 24 or the right button zone 26 (as shown in FIG. 3B), the touch signal corresponds to the mouse mode. Similarly, when the finger does a double clicking at the touch point 28 on the left button zone 24 or the right button zone 26, the touch signal also corresponds to the mouse mode. Herein, the touch signal caused by the operation shown in FIG. 3B represents an instruction that the user clicks the left button or right button of the mouse.

In order to determine whether the touch signal is generated by sliding on the surface of the touch panel or by a single click on the surface of the touch panel, the touch input device 20 determines a first time period the finger touches the surface of the touch panel, and determines a second time period between a time point the finger is removed from the surface, and a time point the finger touches the surface again. If the first time period is less than a first time threshold value, the touch is defined as a click. If the first time period is greater than or equal to the first time threshold value, the touch is defined as a continuous pressing. If the first time period is less than the first time threshold value and the second time period is less than a second time threshold value, this touch is defined as a single-click causing the touch signal. If the finger continuously touches a small zone of the surface twice in a third time threshold value, the touch is defined as a double-click causing the touch signal. The two touch points 28 that form the double-click are at different locations adjacent to each other. If the first time period is greater than or equal to the first time threshold value and the location of the touch point 28 changes, this touch is defined as a sliding.

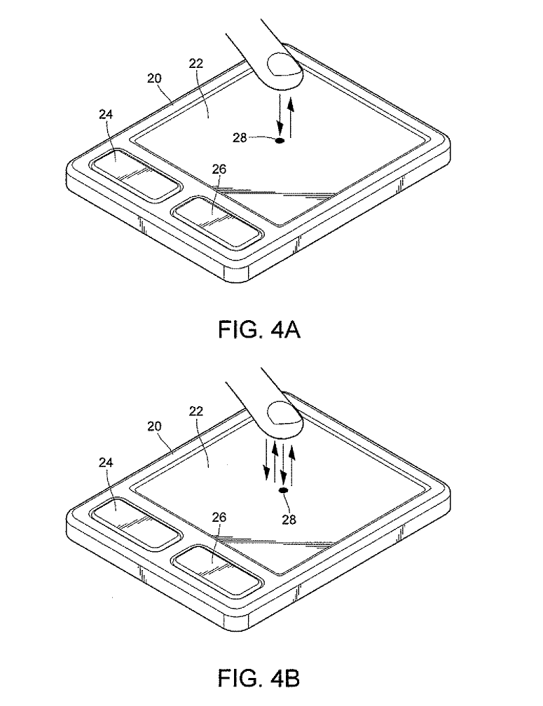

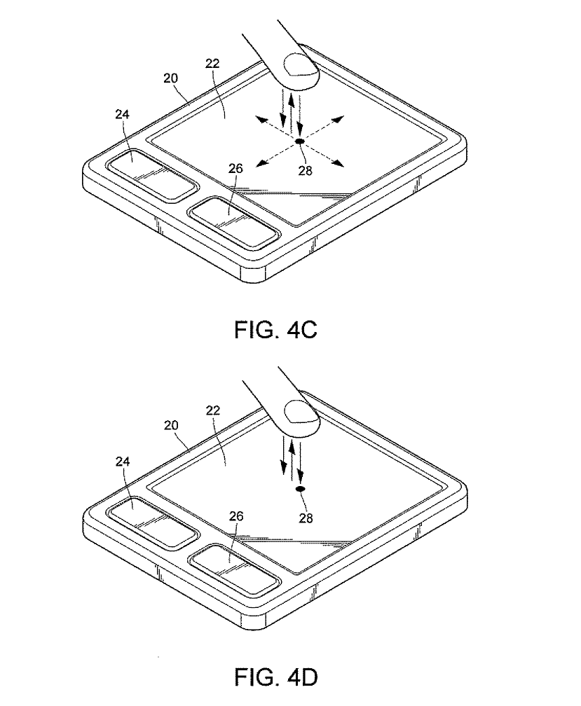

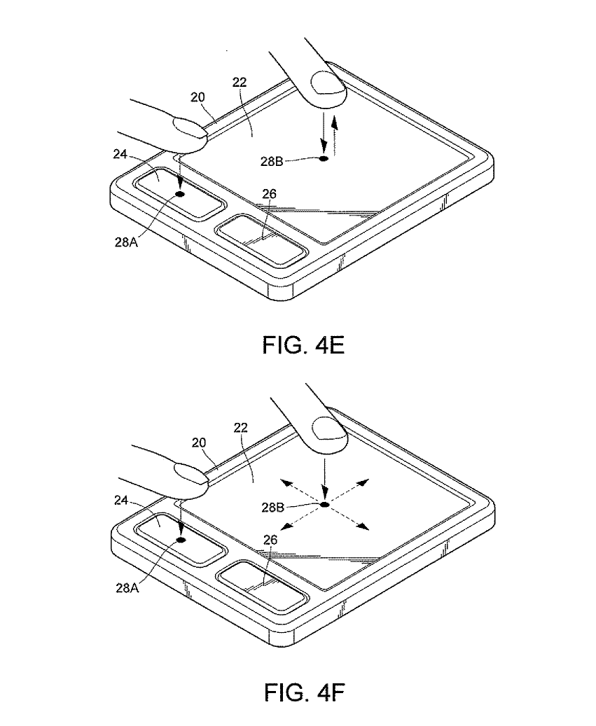

FIG. 4A to FIG. 4F are respectively schematic diagrams of operations causing the touch signal corresponding to a touchpad mode according to different embodiments. When the touch signal is generated by a single-click on the track sensing zone 22 (as shown in FIG. 4A), the touch signal corresponds to the touchpad mode. When the touch signal is generated by a double-click on the track sensing zone 22 (as shown in FIG. 4B), the touch signal also corresponds to the touchpad mode. No matter the single-click or the double-clicks on the track sensing zone 22 occur at one touch point 28 or a plurality of touch points 28, the touch signal is defined to correspond to the touchpad mode. In other words, if a single-click at one touch point 28 (a single touch point), a double-clock at different touch points, single-clicks at different touch points, or multi-clicks at different touch points occur in the track sensing zone 22, the touch signal will be defined to correspond to the touchpad mode.

When the touch signal is generated by a single click at one touch point 28 (a single touch point) on the track sensing zone 22 and then sliding on the track sensing zone 22 in a third time threshold value (as shown in FIG. 4C), the touch signal corresponds to the touchpad mode. Similarly, when the touch signal is generated by single clicks at a plurality of touch points 28 on the track sensing zone 22 and then sliding on the track sensing zone 22 in a third time threshold value, the touch signal also corresponds to the touchpad mode.

When the touch signal is generated by a single-click on the track sensing zone 22 and then continuously pressing the track sensing zone 22 (as shown in FIG. 4D), the touch signal corresponds to the touchpad mode. Similarly, no matter if the touch signal is generated by a single-click at one touch point 28 (a single touch point) or single-clicks at different touch points 28 occur in the track sensing zone 22 and then continuously pressing the track sensing zone 22, the touch signal corresponds to the touchpad mode.

When the touch signal is generated by continuously pressing the left button zone 24 or the right button zone 26 at a single touch point (a first touch point 28A), and meanwhile by a single click at another touch point (a second touch point 2813) in the track sensing zone 22 (as shown in FIG. 4E), the touch signal corresponds to the touchpad mode. If the touch signal is generated by continuously pressing the left button zone 24 or the right button zone 26 at the first touch point 28A, and by meanwhile a double-click at the second touch point 28B in the track sensing zone 22, the touch signal also corresponds to the touchpad mode. For example, a user can continuously press the left button zone 24 with the left index finger, and then click the track sensing zone 22 with the right index finger as shown in FIG. 4E, the touch signal corresponds to the touchpad mode.

When the touch signal is generated by continuously pressing the left button zone 24 or the right button zone 26 at a single touch point (the first touch point 28A), and meanwhile by touching another touch point (the second touch point 28B) in the track sensing zone 22 and then sliding (as shown in FIG. 4F), the touch signal corresponds to the touchpad mode. For example, a user continuously presses the left button zone 24 with the left index finger, and then draws a trace from right to left on the track sensing zone 22 with the right index finger, so as to perform a page turning function on a document, file or webpage.

According to an embodiment, the touch input device 20 is preset to operate under the mouse mode. Therefore, when no touch occurs, the touch input device 20 maintains under the mouse mode. After a finger is removed from the surface of the touch panel and then a touch signal corresponding to the touchpad mode is sent, the touch input device 20 also returns to the mouse mode.

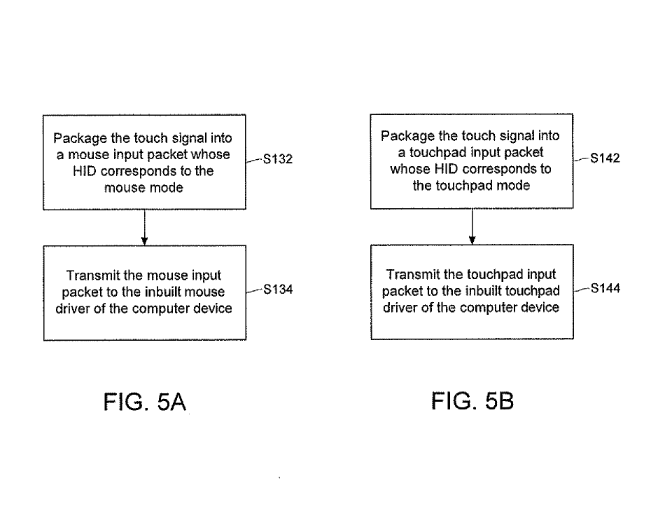

FIG. 5A and FIG. 5B are respectively flow charts of Step S130 and Step S140. Data transmission via a first channel 40 in FIG. 1 and data transmission via a second channel 50 in FIG. 1 are illustrated below with reference to FIG. 5A and FIG. 5B respectively.

When the touch signal corresponds to the mouse mode, the touch input device 20 first packages the touch signal into a mouse input packet. An HID of the mouse input packet corresponds to the mouse mode (Step S132). Then, the touch input device 20 transmits the mouse input packet to the inbuilt mouse driver 32 of the computer device 30 through the first channel 40 (Step S134). When the touch signal corresponds to the touchpad mode, the touch input device 20 first packages the touch signal into a touchpad input packet. An HID of the touchpad input packet corresponds to the touchpad mode (Step S142). Then, the touch input device 20 transmits the touchpad input packet to the inbuilt touchpad driver 34 of the computer device 30 through the second channel 50 (Step S144). Moreover, in this embodiment and some embodiments, the touch input device 20 transmits the mouse input packet or the touchpad input packet to the computer device 30 wiredly or wirelessly.

Specifically, the touch input device 20 specifies a packet transmission destination by specifying an HID of the packet, so as to send the mouse input packet with its HID or the touchpad input packet with its HID to a corresponding driver. Hereinafter, the manner of specifying the HID of the mouse input packet to transmit the mouse input packet is defined as the first channel 40 for making a communication with the computer device 30, and the manner of specifying the HID of the touchpad input packet to transmit the touchpad input packet is defined as the second channel 50 for making a communication with the computer device 30.

For example, each of the touch input device 20 and the computer device 30 includes a communication module used for transmitting or receiving the mouse input packet or the touchpad input packet wiredly or wirelessly. When receiving a packet, the communication module of the computer device 30 reads the header of the packet so as to determine a destination of the packet.

Assume that the HIDs corresponding to the inbuilt mouse driver 32 and the inbuilt touchpad driver 34 are 001 and 010 respectively. When the touch input device 20 generates a mouse input packet, 001 is written into an HID field of the mouse input packet. When the touch input device 20 generates a touchpad input packet, 010 is written in to an HID field of the touchpad input packet. When receiving a packet, the communication module reads the HID in the header of the packet and transmits the packet to the inbuilt mouse driver 32 or the inbuilt touchpad driver 34 according to the HID.

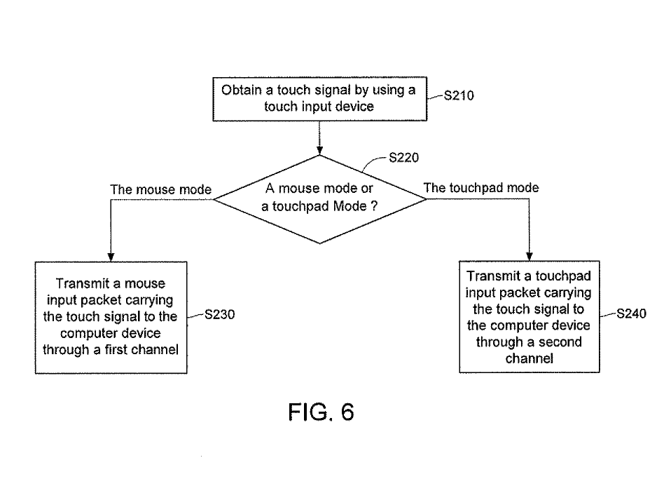

In addition, the process of a signal transmitting method of a touch input device according to another embodiment is shown in FIG. 6. In this embodiment, the signal transmitting method includes the following steps. A touch signal is obtained by using the touch input device 20 (Step S210). Whether the touch signal corresponds to a mouse mode or a touchpad mode is determined (Step S220). When the touch signal corresponds to the mouse mode, a mouse input packet carrying the touch signal is transmitted to a computer device 30 through a first channel 40 (Step S230). When the touch signal corresponds to the touchpad mode, a touchpad input packet carrying the touch signal is transmitted to the computer device 30 through a second channel 50 (Step S240). The first channel 40 is different from the second channel 50. Besides, in this embodiment and some embodiments, the mouse input packet has its HID corresponding to the mouse mode, and the touchpad input packet has its HID corresponding to the touchpad mode.

As set forth above, the touch input device can provide the mouse function and the touchpad function at the same time, and can replace mice and touchpads. Thus, a mouse does not need to be used additionally, and data input may become more efficient. Moreover, the touch input device can send the touch signal to the original inbuilt mouse driver or the original inbuilt touchpad driver in the computer device according to the mode corresponding to the touch signal, so a new driver is not required to be installed in advance. The touch input device may have higher universality.

What is claimed is:

1. A signal transmitting method of a touch input device, adapted to the touch input device and a computer device connected with each other, comprising:
obtaining a touch signal by using the touch input device;
when the touch signal corresponds to a mouse mode, transmitting the touch signal to an inbuilt mouse driver of the computer device through a first channel; and
when the touch signal corresponds to a touchpad mode, transmitting the touch signal to an inbuilt touchpad driver of the computer device through a second channel different from the first channel.

2. The signal transmitting method according to claim 1, wherein the touch input device comprises a track sensing zone, and the touch signal generated by directly touching the track sensing zone at a single touch point and then sliding on the track sensing zone, the touch signal corresponds to the mouse mode.

3. The signal transmitting method according to claim 2, wherein the touch input device further comprises a left button zone and a right button zone, and the touch signal generated by a single-click at a single touch point on the left button zone or the right button zone corresponds to the mouse mode.

4. The signal transmitting method according to claim 1, wherein the touch input device comprises a track sensing zone, and the touch signal generated by a single click or a double click on the track sensing zone corresponds to the touchpad mode.

5. The signal transmitting method according to claim 4, wherein the touch input device further comprises a left button zone and a right button zone, and the touch signal generated by continuously pressing the left button zone or the right button zone at a single touch point and by the single click on the track sensing zone simultaneously, corresponds to the touchpad mode.

6. The signal transmitting method according to claim 5, wherein the touch signal generated by continuously pressing the left button zone or the right button zone at the single touch point and by sliding on the track sensing zone simultaneously corresponds to the touchpad mode.

7. The signal transmitting method according to claim 1, wherein the step of transmitting the touch signal to the inbuilt mouse driver of the computer device through the first channel comprises:
packaging the touch signal into a mouse input packet, a header identification (HID) of the mouse input packet corresponding to the mouse mode; and
transmitting the mouse input packet to the inbuilt mouse driver of the computer device.

8. The signal transmitting method according to claim 1, wherein the step of transmitting the touch signal to the inbuilt touchpad driver of the computer device through the second channel comprises:
packaging the touch signal into a touchpad input packet, an HID of the touchpad input packet corresponding to the touchpad mode; and
transmitting the touchpad input packet to the inbuilt touchpad driver of the computer device.

9. A signal transmitting method of a touch input device, adapted to the touch input device and a computer device connected with each other, comprising:
obtaining a touch signal by using the touch input device;
when the touch signal corresponds to a mouse mode, transmitting the touch signal carried by a mouse input packet, to the computer device through a first channel; and
when the touch signal corresponds to a touchpad mode, transmitting the touch signal carried by a touchpad input packet, to the computer device through a second channel different from the first channel.

10. The signal transmitting method according to claim 9, wherein the mouse input packet has a header identification (HID) corresponding to the mouse mode, and the touchpad input packet has a HID corresponding to the touchpad mode.
